(19) United States
(12) Patent Application Publication
(10) Pub. No.: US 2007/0210560 A1
(43) Pub. Date: Sep. 13, 2007

(54) HANDLE ACCESSORY FOR GRASPING BY AMBULATORY CHILDREN

(76) Inventor: Jennifer A. Groover, Swarthmore, PA (US)

Correspondence Address: SYNNESTVEDT & LECHNER, LLP, 1101 MARKET STREET, 26TH FLOOR, PHILADELPHIA, PA, 19107-2950, US

(21) Appl. No.: 11/676,068

(22) Filed: Feb. 16, 2007

Related U.S. Application Data
(60) Provisional application No. 60/774,945, filed on Feb. 17, 2006.

(51) Int. Cl. B62B 7/00

(52) U.S. Cl. 280/642

(57) ABSTRACT

A handle accessory attachable to a stroller, pram, shopping cart or other wheeled vehicle (collectively, “stroller”) designed for grasping by ambulatory children walking beside the stroller. The handle includes one or more clamps mounted to a laterally elongated bar. The clamps may be of an adjustable-jaw, pivotable stud, or other design suitable for secure mounting on the stroller frame. The clamps can be adjustably tightened to secure the handle to a lower portion of a frame of the stroller. The handle is preferably adjustable to vary spacing between the clamps. A handle portion of the bar extends beyond an area between the clamps and thus is disposed to extend laterally of the stroller so that an ambulatory child may comfortably grasp the bar while walking beside the stroller. A cushioned grip member and an end cap may be provided on the handle portion of the bar.

### CROSS-REFERENCE TO RELATED APPLICATION

This application claims the benefit of priority of U.S. Provisional Patent Application No. 60/774,945, filed Feb. 17, 2006, the entire disclosure of which is hereby incorporated herein by reference.

### FIELD OF THE INVENTION

The present invention relates generally to baby strollers, and more particularly to a stroller-mountable handle positioned and oriented for grasping by an ambulatory child walking beside the stroller.

### BACKGROUND OF THE INVENTION

Baby strollers of various configurations are well-known and readily commercially available. Such strollers are used to carry a young child while a parent walks behind and pushes the stroller. A typical conventional stroller includes a rigid frame carried on three or more wheels and supporting a child seat, which is typically made of fabric or similar material. The frame typically includes tubular, cylindrical, substantially cylindrical frame members. A conventional stroller includes one or more handles toward a top end of the frame that are grasped by a parent/adult while pushing a stroller. A conventional stroller may also include a grab bar positioned above and extending across the width of the stroller's seat so that a child riding in the seat may easily grasp the grab bar while riding in the stroller's seat.

Various stroller handle extenders are known in the art for attachment to the stroller's handles and/or a top end the frame of the stroller. These generally upwardly/rearwardly extending handle extenders allow a parent/adult may grasp the stroller at a relatively higher point, making it easier for taller persons to push the stroller without having to bend forward and without accidentally kicking the stroller's wheels while walking behind it.

While these conventional grab bars and handle extenders address certain needs of a child riding in the stroller and an adult walking behind and pushing the stroller, they do not address certain needs of additional ambulatory children, such as an older sibling of the child riding in the stroller. It has been found to be difficult for an adult pushing the stroller to keep an additional ambulatory child close at hand, particularly when both of the adult's hands are required to grasp and maneuver the stroller.

### SUMMARY

The present invention provides a handle designed for use by ambulatory children walking beside a stroller, pram, shopping cart or other wheeled vehicle (collectively, “stroller”). The handle can be used by a potential rider of the stroller when not riding in the stroller, or by older siblings, etc. when a younger sibling is riding in the stroller. The handle includes one or more clamps that can be adjustably tightened to secure the handle to a lower portion of the frame of the stroller. The handle also includes a laterally extending bar. A support portion of the bar extends between and is secured to the clamp(s). The bar is mountable to the stroller by the clamp(s). A handle portion of the bar is extends beyond an area between the clamp(s) and thus is disposed to extend laterally of the stroller, beyond a lateral edge of the stroller/stroller seat when the bar is mounted to the stroller. In this manner, the bar extends laterally of the stroller, through a space adjacent to the stroller, so that an ambulatory child may comfortably grasp the bar while walking beside the stroller. The handle therefore assists an adult that is walking behind and pushing the stroller to keep an additional ambulatory child close at hand, by providing a stroller-attached handle for grasping by the ambulatory child. The ambulatory child is motivated to grasp the handle by the adult's urging, or by the ambulatory child's desire to help the adult, push the stroller, etc., which is particularly helpful in keeping the ambulatory child close at hand when both of the adult's hands are required to grasp and maneuver the stroller.

### BRIEF DESCRIPTION OF THE DRAWINGS

The present invention will now be described by way of example with reference to the following drawings in which:

FIG. 1 is a perspective view of an exemplary handle in accordance with a first embodiment of the present invention; and

FIG. 2 is a perspective view of an exemplary handle in accordance with an alternative embodiment of the present invention.

### DETAILED DESCRIPTION

The present invention provides a handle accessory 10 designed for manual grasping by ambulatory children walking beside (i.e., outside of positions ahead of or behind the stroller along the intended direction of travel) a stroller, pram, shopping cart, etc. (collectively “stroller”). The handle accessory 10 can be used by the rider of the stroller when not riding in the stroller, or by siblings, etc. when a child is riding in the stroller.

The handle accessory 10 includes at least one clamp securable to the frame of a stroller to support the handle accessory on the frame in a stable manner. Each clamp includes opposed structures for embracing opposed portions of the frame. By way of example, each clamp may have rigid movable opposed structures, or be a unitary body including opposed resilient structures. Various clamps are known in the art, and any suitable clamp may be used. Tool-free clamps, i.e. those requiring only manual manipulation to be mounted to/demounted from the frame, are preferred.

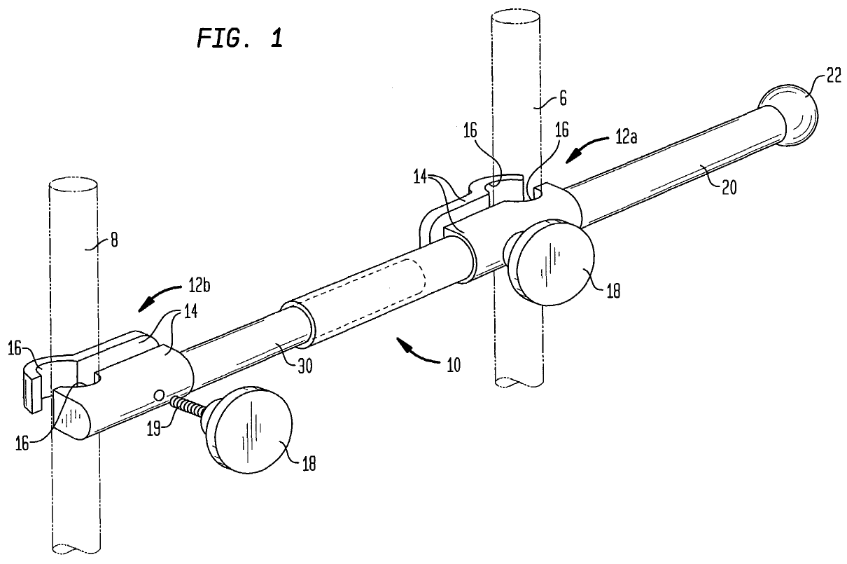

Referring now to FIG. 1, this exemplary handle accessory 10 includes a jaw-clamp 12a having opposed jaws 14 that can be adjustably advanced toward one another to trap a first frame member 6 of the stroller therebetween, and thus tightly secure the handle accessory 10 to the stroller's frame. The jaws 14 preferably include opposing non-linear surfaces, such as arcuate surfaces 16, that are well-suited for securely embracing a cylindrical or non-cylindrical portion of the stroller's frame. The jaw-clamp 12a further includes a thumbscrew 18 having an externally threaded stud 19 passing through the jaws 14 to close the jaws as the thumbscrew 18 is advanced.

The handle accessory 10 also includes a longitudinally extending bar member 20 joined to the jaw-clamp 12a and disposed to extend laterally of the stroller, beyond a lateral edge of the stroller/stroller seat, when mounted to the stroller. In this manner, the bar member 20 extends through a space adjacent the stroller so that a child may comfortably grasp the bar member 20 while walking beside the stroller, as best shown in FIG. 1.

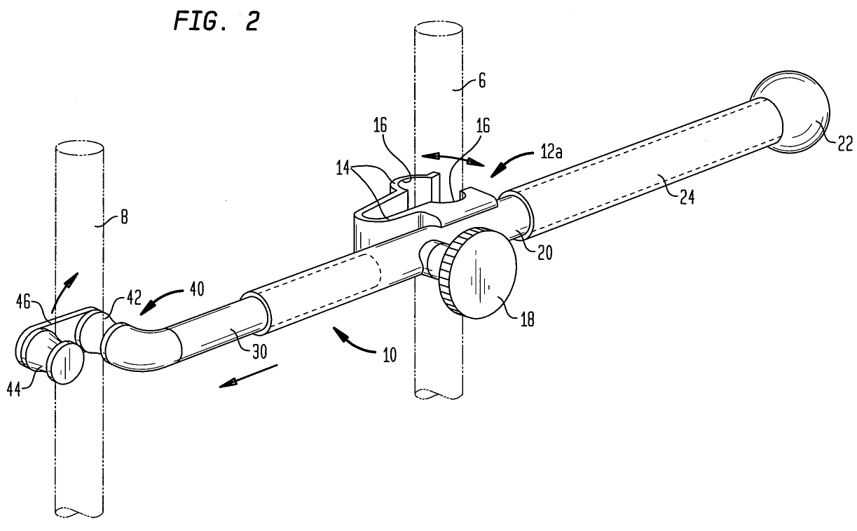

Optionally, a bulbous end cap 22 is mounted on the end of the bar member 20 to safely enclose any sharp or hard edge of the bar member 20 and to facilitate grasping of the handle accessory 10 by a young child. Optionally, a cushioned grip member 24, such as a rubber of foam member having a central opening for receiving the bar member 20, may be provided on the bar member 20 to further facilitate grasping of the handle accessory 10 by a young child, as best shown in FIG. 2.

While the single clamp arrangement for mounting the handle accessory 10 to the stroller frame described above is sufficient, the stability of the handle accessory 10 relative to the stroller frame can be enhanced by providing a second clamp arrangement for mounting the handle accessory 10 to the stroller frame.

In one embodiment, the handle accessory 10 further includes a second clamp that is another jaw-clamp 12b. The second jaw-clamp 12b includes jaws 14 having non-linear, e.g. arcuate, surfaces 16 and a thumbscrew 18 similar to that of the first jaw-clamp 12a discussed above. The second jaw-clamp 12b is movable relative to the first jaw-clamp 12a, so that the second jaw-clamp 12b may be adjustably positioned to secure the handle accessory 10 to a lower portion of a second frame member 8 of the stroller that is in spaced relationship to the first jaw-clamp 12a.

In one embodiment, the jaw-clamp 12b is slidably mounted on a portion of the bar member 20 to allow for adjustment of the space between both clamps 12a, 12b to accommodate a range of spaces between frame members 6, 8 of various strollers (not shown). In another embodiment, the second jaw-clamp 12b is fixedly mounted on an inner bar member 30 that interfits in nested tube configuration with an outer tube portion of the bar member 20, and slides relative thereto to provide the aforementioned moveability to adjust the lateral distance between the clamps, as shown in FIG. 1.

In another embodiment, the second clamp of the handle accessory 10 includes a spring-biased mechanism 40 instead of the second jaw-clamp 12b, as shown in FIG. 2. The spring-biased mechanism 40 includes a first stud 42 and a second stud 44. Optionally, each stud 42, 44 include non-linear, e.g. arcuate, surfaces for engaging the frame members. The second stud 44 is fixedly mounted on a pivotable arm 46 that is rotationally biased by a spring member (not shown) internal to the first stud 42. The second stud 44 is preferably biased to a rotational position in which there is a minimal lateral distance, i.e. less than a common dimension of a frame member, between the two studs 42, 44. In one embodiment, the arm 30 is rotationally biased to a rotational position requiring at least 90 degrees of rotation to longitudinally align the arm 30 with the bar member 20. In FIG. 2, the spring member biases the second stud and arm 46 in a clockwise direction.

Preferably, the spring-biased mechanism 40 is movable relative to the first jaw-clamp 12a, so that the spring-biased mechanism 40 may be adjustably positioned to secure the handle accessory 10 to the second frame member 8 of the stroller in spaced relationship to the first jaw-clamp 12a.

In one such embodiment, the spring-biased mechanism 40 is slidably mounted on a portion of the bar member 20 to allow for adjustment of the space between the jaw-clamp 12a and the spring-biased mechanism 40 to accommodate a range of spaces between frame members 6, 8 of various strollers (not shown). In another embodiment, the spring-biased mechanism 40 is fixedly mounted on an inner bar member 30 that interfits in nested tube configuration with an outer tube portion of the bar member 20, and slides relative thereto to provide the aforementioned moveability to adjust the lateral distance between the clamps, as shown in FIG. 2.

In use, the second stud 44 and arm 46 is manually pivoted against the bias (counterclockwise in FIG. 2) to provide a sufficient lateral distance between the two studs 42, 44 to permit the frame member 8 to pass therebetween. Second stud 44 and arm 46 may then be released, allowing the arm 46 to resile and thus rotate in a clockwise direction to a position at which the frame member 8 is securely embraced between the first and second studs 42, 44. The spring-biased mechanism's studs 42, 44, and thus the handle accessory 10, is maintained in a secure position by the spring-biased mechanism's spring tension.

Preferably, the handle accessory 10 is mounted on the stroller at a position significantly lower than the stroller's adult-height handles, i.e., at a position about 18 inches-36 inches above the ground when the stroller's wheels are resting on the ground. This positions the handle accessory 10 at a location at which it may be conveniently grasped by a young child walking on the ground beside the stroller.

In use, the handle accessory 10 may be selectively secured to and removed from a stroller as desired, e.g. after and before unfolding and folding the stroller for use and storage, and the portion of the bar member 20 extending adjacent to the stroller, i.e. outside of the portion between the frame members 6, 8, may be grasped by a young child, at a convenient height, while the young child walks beside the stroller as it is pushed by an adult grasping the stroller's adult-height handles. In this manner, for example, a single adult can conveniently supervise two children simultaneously, one riding in the stroller, the other walking beside the stroller and grasping the handle accessory 10.

What is claimed is:

1. A handle accessory for mounting to a frame of a wheeled stroller, the handle accessory comprising:
a first clamp releasably securable to the frame;
an elongated bar member joined to said first clamp, said elongated bar member comprising a handle portion disposed to extend laterally from the wheeled stroller when said first clamp is secured to the frame.

2. The handle accessory of claim 1, further comprising a second clamp releasably securable to the frame, the second clamp being joined to said elongated bar member.

3. The handle accessory of claim 2, wherein a separation distance between said first and second clamps is adjustable to correspond to a respective lateral distance between individual frame members of the frame.

4. The handle accessory of claim 3, wherein said elongated bar member comprises an inner bar member and an outer tube interfitting in a nested tube configuration, said inner bar member being longitudinally slidable within said outer tube to adjust the separation distance between said at least one first and second clamps.

5. The handle accessory of claim 1, wherein at least one of said first and second clamps comprises a pair of opposed jaws supporting a threaded bolt configured to adjust a distance between the opposed jaws to cause said at least one of said first and second clamps to grasp the frame.

6. The handle accessory of claim 5, wherein each of said pair of opposed jaws comprises a non-linear surface configured to receive the frame.

7. The handle accessory of claim 6, wherein each non-linear surface comprises an arcuate surface configured to receive the frame.

8. The handle accessory of claim 5, wherein each or said pair of opposed jaws comprises a separate member.

9. The handle accessory of claim 5, wherein said pair of opposed jaws are joined together as a unitary body.

10. The handle accessory of claim 1, wherein at least one of said first and second clamps comprises a spring-biased mechanism comprising a first stud fixed in longitudinal position relative to at least a portion of the bar member, and a second stud fixedly positioned on an arm mounted for rotational movement about said first stud.

11. The handle accessory of claim 10, wherein arm is rotationally biased by a spring member.

12. The handle accessory of claim 11, wherein the arm is rotationally biased to a rotational position requiring at least 90 degrees of rotation to longitudinally align said arm with said bar member.

13. The handle accessory of claim 1, wherein the spring-biased mechanism is slidably mounted relative to the bar member.

14. The handle accessory of claim 2, wherein said handle portion extends beyond an area between said first and second clamps to a distal end of said bar member.

15. The handle accessory of claim 14, further comprising a grip member supported on said bar member along said handle portion.

16. The handle accessory of claim 14, further comprising a bulbous end cap concealing said distal end of said bar member.

17. A handle accessory for mounting to a frame of a wheeled stroller, the handle accessory comprising:
a clamp releasably securable to the frame;
an elongated bar member supporting said clamp in a position longitudinally adjustable to correspond to a respective lateral distance between individual frame members of the frame, a handle portion of said elongated bar member being disposed to extend laterally from the wheeled stroller when said bar member is secured to the frame.

18. The handle accessory of claim 17, wherein at said clamp comprises a pair of opposed jaws supporting a threaded bolt configured to adjust a distance between the opposed jaws to cause said clamp to grasp the frame.

19. A handle accessory for mounting to a frame of a wheeled stroller, the handle accessory comprising:
a first clamp comprising a first pair of opposed jaws supporting a first threaded bolt configured to adjust a distance between the opposed jaws to cause the first clamp to securely grasp the frame;
a second clamp comprising a second pair of opposed jaws supporting a second threaded bolt configured to adjust a respective distance between the opposed jaws to cause the second clamp to securely grasp the frame; and
an elongated bar member supporting said first and second clamps, at least one of said first and second clamps being supported in a position longitudinally adjustable to provide a separation distance between said first and second clamps corresponding to a respective lateral distance between individual frame members of the frame, said elongated bar member comprising a handle portion disposed to extend laterally from the wheeled stroller when said first clamp is secured to the frame.

20. The handle accessory of claim 19, wherein said elongated bar member comprises an inner bar member and an outer tube interfitting in a nested tube configuration, said inner bar member being longitudinally slidable within said outer tube to adjust the separation distance between said first and second clamps.
